(19) United States
(12) Patent Application Publication
(10) Pub. No.: US 2007/0139367 A1
(43) Pub. Date: Jun. 21, 2007

(54) Apparatus and method for providing non-tactile text entry

(76) Inventor: Glen P. Goffin, Dublin, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/313,982

(22) Filed: Dec. 21, 2005

(51) Int. Cl. G09G 5/00

(52) U.S. Cl. 345/156

(57) ABSTRACT

A non-tactile system and method of text entry on a device is disclosed, comprising capturing printed text as an image using a camera associated with the device, performing optical character recognition on the image to yield text recognizable by the device, and storing the text on the device. In one embodiment, text is handwritten by a user of paper and held in front of a camera on a device such as a video telephone. The video telephone utilizes optical character recognition to interpret the handwritten text into text recognizable by the phone. The user can thereby enter text into a device without use of a keyboard or touch screen device.

### BACKGROUND OF THE DISCLOSURE

1. Field of the Disclosure

The present disclosure relates to text entry. In particular, it relates to a text entry system and method for use in devices without a tactile user interface such as a keyboard, mouse, or touch screen.

2. General Background

An interface device (IDF) is a hardware component or system of components that allows a human being to interact with a computer, a telephone system, or other electronic information system. Common examples of tactile interfaces include keyboard, mouse, numerical keypad, and touch screen. Keyboards are perhaps the simplest method for entry of text.

Use of a keyboard, mouse, and touch screen are popular methods of interfacing with devices.

Telephones for example typically have a numeric keypad for entering numbers. It is possible to enter text using a numeric keypad, however the process can be rather cumbersome. One method of entering text on a numerical keypad involves entering a letter by repeatedly pressing a key until the letter you want appears. T9 Text Input or Predictive Text input allows the user to press each key only one time per letter just like on a keyboard. Software finds all the words that can be spelled with the sequence of keys and lists them with the words you are most likely to want appearing higher on the list.

However, as the need for smaller and less expensive devices arises, improved methods of interfacing with such devices are required.

### SUMMARY

A non-tactile system and method of text entry on a device is hereby disclosed. In one embodiment, printed text is captured as an image by the device. The device performs optical character recognition on the image to yield text recognizable by the device. The text recognizable by the device is then optionally stored on the device.

In yet another aspect, a device comprising a non-tactile user interface is disclosed. A camera is configured to capture an image of printed text when positioned in view of the camera. Further, a processing means is in communication with the camera. The processing means is configured to perform optical character recognition on the image. In addition, the non-tactile user interface may be used to enter text information into the device.

### BRIEF DESCRIPTION OF THE DRAWINGS

FIG. 1 is an exemplary embodiment of a system in accordance with the present disclosure.

FIG. 2 is a diagram of an exemplary system of non-tactile text entry for a device.

FIG. 3 is a block flow diagram of one embodiment of a method a method of non-tactile text entry for a device.

FIG. 4 is a block flow diagram of one embodiment of a method a method of non-tactile text entry for a device.

### DETAILED DESCRIPTION

A non-tactile system and method of text entry on a device is hereby disclosed. In one embodiment, printed text is captured as an image by the device. The device performs optical character recognition on the image to yield text recognizable by the device. The text recognizable by the device is then optionally stored on the device.

The system and method of non-tactile text entry can be used for any device comprising at least a processing means, and a camera. In one embodiment, the method of text entry is employed in a device such as a video telephone comprising at least a camera and a display screen. Eliminating the need for additional interface devices such as a keyboard or touch screen ensure that the overall size and cost of the device are kept to a minimum.

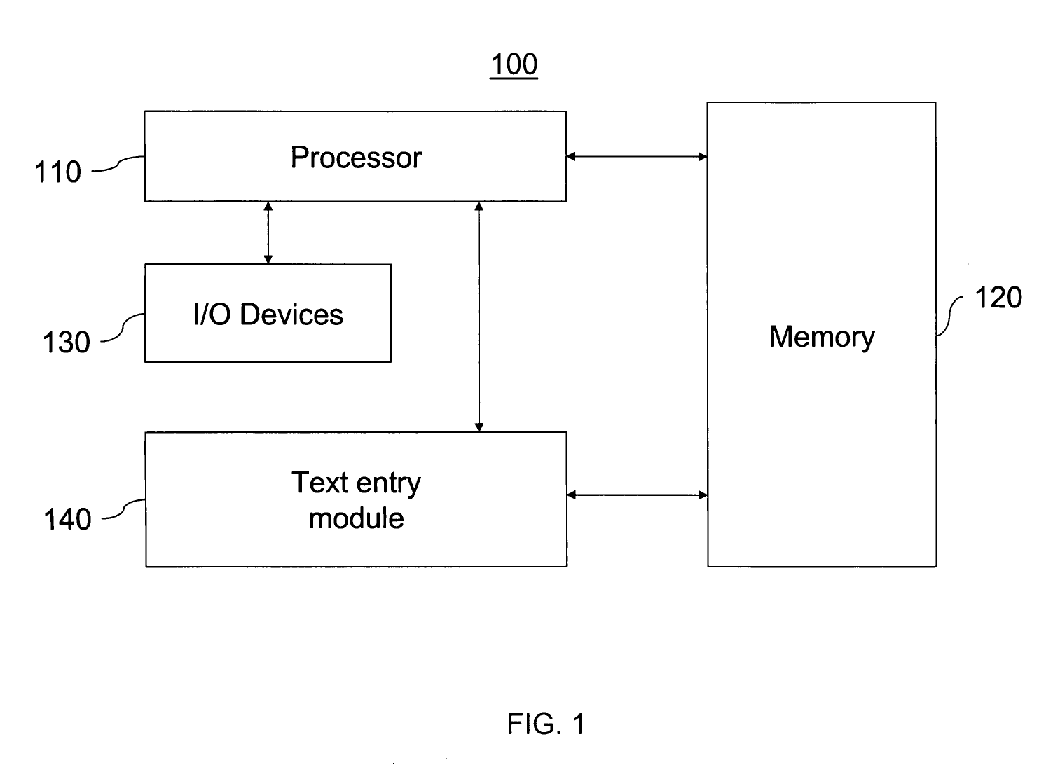

FIG. 1 illustrates a block diagram of a non-tactile text entry device or system 100 in accordance with the present disclosure. Specifically, the system can be employed to enter text from a user without use of a keyboard or mouse. In one embodiment, the non-tactile text entry device or system 100 is implemented using a general purpose computer or any other hardware equivalents.

Thus, image processing device or system 100 comprises a processor (CPU) 110, a memory 120, e.g., random access memory (RAM) and/or read only memory (ROM), text entry module 140, and various input/output devices 130, (e.g., storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)).

It should be understood that the text entry module 140 can be implemented as one or more physical devices that are coupled to the CPU 110 through a communication channel. Alternatively, the text entry module 140 can be represented by one or more software applications (or even a combination of software and hardware, e.g., using application specific integrated circuits (ASIC)), where the software is loaded from a storage medium, (e.g., a magnetic or optical drive or diskette) and operated by the CPU in the memory 120 of the computer. As such, the text entry module 140 (including associated data structures) of the present invention can be stored on a computer readable medium, e.g., RAM memory, magnetic or optical drive or diskette and the like.

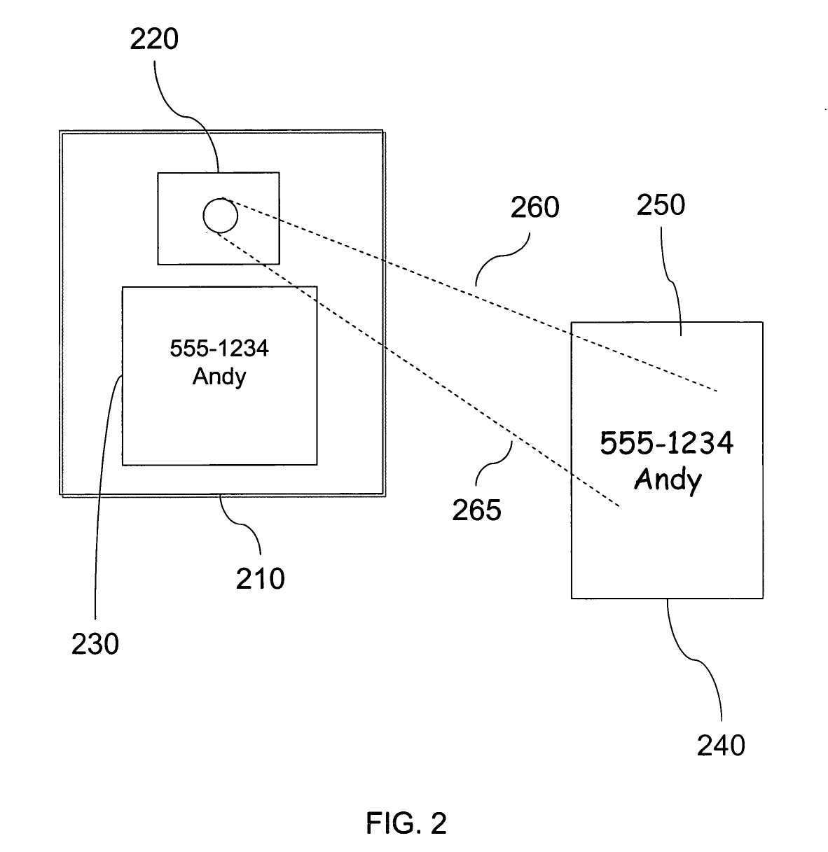

FIG. 2 illustrates an exemplary embodiment of a non-tactile text entry system in accordance with the present disclosure. Device 210 comprises a camera 220 and display 230. Device 210 may for example be a video telephone. Video telephones commonly employ at least a camera 220 and a display 230, the camera 220 being used to take pictures and/or video of the user, and the display 230 being for displaying pictures and/or video of another user they may be communicating with.

In one embodiment, the user interacting with device 210 handwrites text 250 on medium 240. The medium 240 may for example be paper. Alternatively, in another embodiment, text 250 may be text printed by a machine such a printer or printing press. For example, the text may be pre-printed from a computer printout, a newspaper, magazine, or business card.

Camera 230 generally has an area of view as characterized by the area between dotted lines 260 and 265. Text 250 is oriented by the user to be within the view of the camera 230, as indicated in FIG. 2. In one embodiment, the view of the camera is displayed on display 220 so that the user can properly position the text in the area of view.

In an exemplary embodiment, the text entry method is employed in a device 210 such as a video phone without an alphanumeric keyboard or touch screen display. One could write the words they want to enter 250 on a piece of paper 240 and hold it in front of the camera 230 associated with the video phone. The phone could use optical character recognition and “grab” the word to automatically fill in the current field (field with the focus).

For example, the user might enter a PIN code by just holding up a piece of paper with the PIN code written on it. The video phone would recognize the digits and accept them as the user's alphanumeric response to the PIN code query dialog box. This same principle could be used for any user I/O entry on the phone such as URL's, phonebook entries, etc. For example, a user could write a friend's complete contact information including phone numbers, address, email and the like and hold that piece of paper in front of the phone. The phone could optically recognize the whole record and automatically enter it as a new phonebook entry. Furthermore, a special symbol could be used to tell the phone that this is a new phonebook entry. The symbol would not have to be alphanumeric. It could be simple graphic symbol.

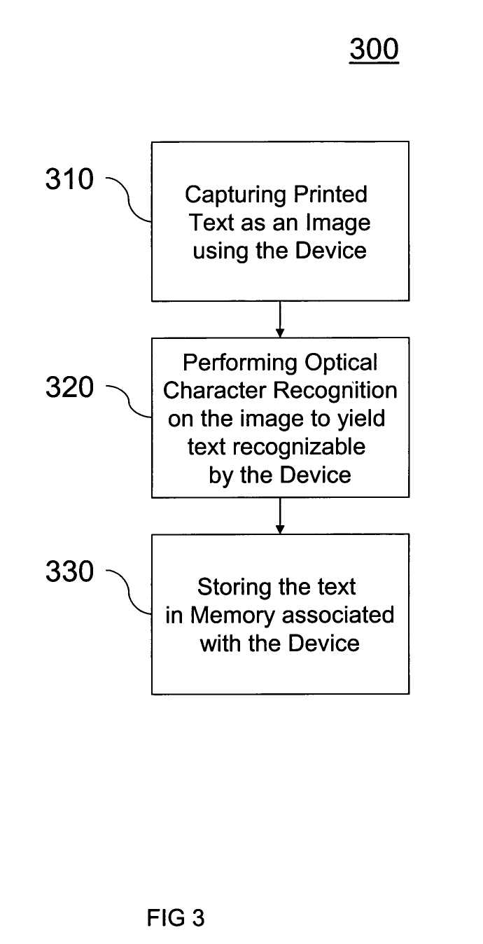

FIG. 3 illustrates a block flow diagram of the steps involved in an exemplary text-entry method in accordance with the present disclosure. Printed text is first captured as an image using the device, as indicated at block 310. As mentioned above, the device may comprise a camera, and the camera captures printed text as an image. Optical character recognition is then performed on the image, as indicated at block 320. The optical character recognition process yields text recognizable by the device. The text is then stored in memory associated with the device, as indicated at block 330. The text recognizable by the device may for example be stored in an address book for later access by a user. The text recognizable by the device may also for example be stored in temporary memory.

A trigger may be used to cause the device to capture the image. The trigger may be an input received by the user. For example, the trigger might comprise pressing a button or voice prompts. Alternatively, the device may be intelligent enough to trigger capture of the image itself. For example, the device could recognize when the text is bounded within a predetermined area, optionally after the text has stabilized within a pre-determined time, and trigger capture of the image itself. In yet another embodiment, audio or visual cues could be used to trigger the optical recognition and translation process. In other words, hold up the image, say “enter” and the device captures the image and performs the recognition process. In another embodiment, a visual trigger could trigger the device to capture be things like just holding the paper still for some number of seconds.

There are several benefits of a non-tactile text entry system and method. For example, there is need for additional interface devices such as bulky keyboards or expensive touch screens. Furthermore, in telephones where use of cameras is becoming increasingly common, the text entry method is substantially easier than entering text on a numerical keypad, which involves repeatedly pressing numbers in order to translate to a single letter.

In another aspect, a method of text entry on a device without a tactile user interface is disclosed. The method comprises displaying a text entry area on a display screen associated with the device, positioning printed text in front of a camera associated with the device, superimposing the image of the printed text viewed by the camera on the display; and capturing an image of the printed text when the printed text is substantially aligned with the text entry area.

The text entry area may for example be a box, within which the text should be placed. The text entry area could alternatively be a line, or multiple lines. The user then orients the text to fall in between, above, or below the lines. The text entry area may be transparent or semi-transparent such that the user can simultaneously view the text entry area and the image of the printed text viewed by the camera.

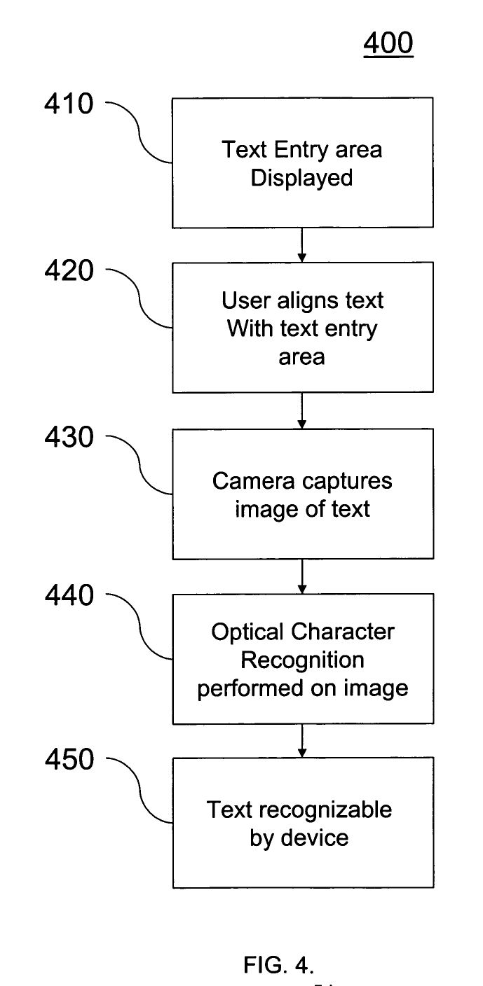

FIG. 4 illustrates a flow diagram of the process involved in one exemplary embodiment. For example, the device may prompt the user for text entry. A display associated with the device displays a text entry area, as indicated at block 410. In some embodiments, this text entry area could overlay the image seen by the camera with transparency turned on such that the piece of paper with the writing on it overlays the dialog box (or vice versa), that then signals to the phone to perform character recognition and fill in the associated field with that text. The user aligns the text with the text entry area as displayed on the display, as indicated at box 420. In other words, imagine holding a piece of paper with your PIN code written and moving that piece of paper until the text lines up with a PIN code entry area, at which point, the written text on the piece of paper shows up as real text on the entry line. The camera captures the image, as indicated at block 430. Optical character recognition of the text is performed at block 440, and text recognizable by the device is generated as a result, as indicated at block 450.

This would enable there to be more than one field on the phone to be filled in at a time and the phone would know which field by having the user align the written text with the associated text entry area. For example, a text entry input form might comprise a plurality of fields, each having a text entry area associated with it. A moving focus, such as highlighting, a cursor, icon, etc could be used to prompt the user to move the text to align with the specified text entry area. Alternatively, a single text entry area could be used for text entry into a plurality of different fields.

A similar solution can be had by using a touch-screen solution and having the user write directly on the touch screen as is done with PDA's today. This solution can be used for lower cost phones that don't support touch screens.

A user defined “symbology” lexicon—the user can define symbols for different phone operations and “train” them on the phone. When the symbol is held in front of the camera, the symbol instructs the phone what action to take. The training process could be a wizard-like process or a simple association process where an action is invoked and the associated symbol is shown to the phone. For example, use of a special character such as “*” could prompt the device to move to the next field. Therefore, writing “Andy*555-1234” could prompt the device to enter “Andy” into a first field (for name), the “*” is recognized as a special character indicating the text following it is a new field. “555-1234” is then entered into a second field (for telephone number).

Furthermore, it is anticipated that physical gestures such as hand gestures could be used to perform operations. For example, a special gesture could be used to indicate the device erase a character or characters in a field. Similarly, a gesture could be used to confirm that the text recognized and entered into a field is correct. Gestures could either include body actions like clockwise circular movements for commit and counterclockwise for erase (as examples), movements of the handwritten documents, symbols written by the user, etc.

Other methods of indicating the device to perform operations may include use of one or more buttons (for example, on a phone this might be the “*” or the “#” key or alternatively soft-keys that are labeled “KEEP” or “ERASE”) or voice prompts.

A learning process where the same piece of paper can be used for continuing a dialog and the phone remembers the fields on the piece of paper that were already used. In other words, the phone could remember that the 4 digits at the bottom of the paper were the PIN code entered previously and ignore those. This would avoid having to use several scraps of paper.

Dialing based on names rather than telephone numbers could be easily employed. In other words, write a person's name on a piece of paper with the dialing symbol, no longer requiring the user remember the telephone number. The phone could first look in its own contact database to see if there is a telephone number matching the name. Even further, it is foreseen that contact information could be looked up via the Internet or some sort of electronic information service. Writing the name of a person or a business might prompt the phone to look in the published phone listings for numbers that match and place a call accordingly. For example, the phone could access the internet to perform the telephone number lookup process. A user might write, “Gino's Pizza” and the phone accesses the internet, looks up the number and prompts the user to dial.

Although certain illustrative embodiments and methods have been disclosed herein, it will be apparent form the foregoing disclosure to those skilled in the art that variations and modifications of such embodiments and methods may be made without departing from the true spirit and scope of the art disclosed. Many other examples of the art disclosed exist, each differing from others in matters of detail only.

Finally, it will also be apparent to one skilled in the art that the above described system and method of non-tactile text entry could be used for almost any type of device comprising a camera. Accordingly, it is intended that the art disclosed shall be limited only to the extent required by the appended claims and the rules and principles of applicable law.

We claim:

1. A method of text entry on a device comprising:
capturing printed text as an image using the device;
performing optical character recognition on the image to yield text recognizable by the device; and
storing the text in memory associated with the device.

2. The method of claim 1 wherein the device further comprises a camera, and the camera is used to capture the printed text as an image.

3. The method of claim 2 wherein the device further comprises a display.

4. The method of claim 1 wherein the printed text is text printed on paper.

5. The method of claim 1 wherein the printed text is text handwritten by a user.

6. The method of claim 1 wherein the printed text is text printed by a machine.

7. The method of claim 1 wherein the device is without a tactile user interface.

8. The method of claim 1 wherein the device is a telephone.

9. The method of claim 1 wherein the device is a video phone.

10. The method of claim 3 wherein the image viewed by the camera is shown on the display.

11. The method of claim 10 wherein a text entry area is shown on the display.

12. The method of claim 10 further comprising:
simultaneously displaying the image viewed by the camera with the text entry area on the display, wherein aligning the printed text with the text display area triggers the camera to capture the printed text.

13. The method of claim 2 wherein a user orients the printed text in front of the camera in order to capture the image.

14. The method of claim 13 wherein the image viewed by the camera is superimposed on the text entry area.

15. The method of claim 13 wherein the capturing printed text as an image is performed when the printed text is substantially aligned with the text entry area.

16. The method of claim 1 wherein the capturing printed text as an image occurs upon activation of a trigger.

17. The method of claim 16 wherein the trigger comprises pressing a button.

18. The method of claim 16 wherein the trigger comprises a voice command.

19. The method of claim 16 wherein the trigger comprises a predetermined symbol.

20. The method of claim 11 wherein the text entry area is a box.

23. The method of claim 11 wherein the text entry area is a line.

21. The method of claim 1 wherein text is alphanumeric

24. The method of claim 1 wherein text is a telephone number.

25. The method of claim 1 wherein the text is an address.

26. A device comprising a non-tactile user interface comprising:
a camera configured to capture an image of printed text when positioned in view of the camera; and
processing means in communication with the camera, the processing means configured to perform optical character recognition on the image;
the non-tactile user interface being used to enter text information into the device.

27. The method of claim 26 wherein the device is a video phone.

28. A computer readable medium operable on a device having instructions stored thereon configured to perform the steps comprising:
capturing printed text as an image using the device;
performing optical character recognition on the image to yield text recognizable by the device; and
storing the text in memory associated with the device.
